(19) United States
(12) Patent Application Publication
(10) Pub. No.: US 2018/0276984 A1
(43) Pub. Date: Sep. 27, 2018

(54) SIMULTANEOUS CONTROL TERMINAL FOR ELECTRONIC PRODUCTS, SIMULTANEOUS CONTROL SYSTEM FOR ELECTRONIC PRODUCTS, AND COMPUTER-READABLE RECORDING MEDIUM RECORDING PROGRAM EXECUTING SIMULTANEOUS CONTROL METHOD FOR ELECTRONIC PRODUCTS

(71) Applicants: Hyundai Motor Company, Seoul (KR); Kia Motors Corporation, Seoul (KR)

(72) Inventors: Hyoung SHIN, Yongin-si (KR); Hui Sung LEE, Gunpo-si (KR); Youngwook SONG, Seoul (KR); Kichang YI, Suwon-si (KR)

(73) Assignees: Hyundai Motor Company, Seoul (KR); Kia Motors Corporation, Seoul (KR)

(21) Appl. No.: 15/801,062

(22) Filed: Nov. 1, 2017

(30) Foreign Application Priority Data
Mar. 27, 2017 (KR) 10-2017-0038732

(51) Int. Cl. G08C 17/02

(52) U.S. Cl. CPC G08C 17/02; G08C 2201/40

(57) ABSTRACT

A simultaneous control terminal for electronic products connected through a network with a relay module receiving and outputting a first signal that is output from a remote control module in response to a user's operation may include a control information storage configured to store control information corresponding to the remote control module; a receiver configured to receive the first signal output from the relay module; a control information searcher configured to search the control information corresponding to the received first signal; and a transmitter configured to generate a second signal including the searched control information and transmit the second signal to the relay module.

### CROSS-REFERENCE TO RELATED APPLICATION

The present application claims priority to Korean Patent Application No. 10-2017-0038732 filed on Mar. 27, 2017, the entire contents of which is incorporated herein for all purposes by the present reference.

### BACKGROUND OF THE INVENTION

### Field of the Invention

Various embodiments of the present invention relates to a simultaneous control terminal for electronic products, a simultaneous control system for the electronic products, and a computer-readable recording medium recording a program for executing a simultaneous control method for the electronic products.

### Description of Related Art

Home internet of things (IoT) is a platform for collecting and exchanging information by connecting a mobile device and household appliances to the Internet and a communication network. Home appliances, lighting equipment, and security appliances may be controlled inside or outside home using the mobile device with an application related to the Home IoT as a remote controller. A user may lock gas, may turn off a light in a living room, or may cut off power supplied to some home appliances using the mobile device.

However, when the user controls the home appliances, the lighting equipment, and the security appliances to go out, it is troublesome to individually operate the control objects using the mobile device. In addition, a control method for the control objects is complicated in that the user may control various devices in home at a time before going out. A control for the control objects may include gas lock, shutting off power to the home appliances, turning-off of the lighting equipment, setting a temperature of the indoor, and turning-off of a lock sensor. Further, since functions of the home appliances, the lighting equipment, and the security appliances may be selectively controlled based on purpose of the user's going out, a problem including confusing a control sequence or forgetting control of some devices may arise.

The information disclosed in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a simultaneous control terminal for electronic products, a simultaneous control system for the same, and a computer-readable recording medium recording a program executing a simultaneous control method for the same which are configured for simultaneously controlling a plurality of electronic products based on an output signal of a remote controller and control information stored in a user terminal corresponding to the output signal.

In addition to the above-mentioned object, an exemplary embodiment of the present invention may be used for other objects that are not mentioned in detail.

An exemplary embodiment of the present invention may provide the simultaneous control terminal for the electronic products, including: a control information storage configured to store control information corresponding to the remote control module; a control information storage configured to store control information corresponding to the remote control module; a receiver configured to receive the first signal output from the relay module; a control information searcher configured to search the control information corresponding to the received first signal; and a transmitter configured to generate a second signal including the searched control information and transmit the second signal to the relay module.

The control information may include the electronic products to be controlled, an order of control of the electronic products, and control items of the electronic products.

An exemplary embodiment of the present invention may provide the simultaneous control system for the electronic products, including: a remote control module configured to output a first signal corresponding to a user's operation through a first communication network; a relay module configured to receive the first signal through the first communication network and output the received first signal through a second communication network; and a user terminal configured to receive the first signal transmitted from the relay module through the second communication network, generate a second signal including control information corresponding to the received first signal, and transmit the second signal to the relay module.

The remote control module may include a body and a plurality of buttons detachable from the body, and the first signal corresponding to a button operated by the user among the buttons may be output.

The relay module may receive the second signal transmitted from the user terminal and may output a plurality of control signals corresponding to the received second signal.

The control information may include the electronic products to be controlled, an order of control of the electronic products, and control items of the electronic products.

An exemplary embodiment of the present invention may provide a non-transitory computer-readable recording medium recording the program executing the simultaneous control method using the simultaneous control terminal for the electronic products connected through the network with the relay module receiving and outputting the first signal that is output from the remote control module in response to the user's operation, including: a function to store control information on the electronic products in a control information storage; a function to receive the first signal output from the relay module in a receiver; a function to search the control information corresponding to the first signal received by a control information searcher; and a function to generate a second signal corresponding to the searched control information and transmit the second signal to the relay module.

The first signal may include button information related to the remote control module, and the control information may include the electronic products to be controlled, an order of control of the electronic products, and control items of the electronic products.

The control information may be set and modified by the user.

The exemplary embodiment of the present invention may control a plurality of electronic products in response to the user's single manipulation of a remote controller and may easily set and modify control information corresponding to each button of the remote controller using an application disposed in the user terminal so that it improves convenience of the user.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 shows a simplified configuration of a simultaneous control system for electronic products according to an exemplary embodiment of the present invention.

FIG. 2 shows a detailed configuration of the simultaneous control system for the electronic products according to an exemplary embodiment of the present invention.

FIG. 3 shows a method for simultaneously controlling the electronic products using the simultaneous control system of FIG. 2.

It may be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

An exemplary embodiment of the present invention will hereinafter be described in detail with reference to the accompanying drawings. In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification. Further, detailed descriptions of well-known technology may be omitted.

Unless explicitly described to the contrary, the word “comprise” or variations such as “comprises” or “comprising” will be understood to imply the inclusion of stated elements but not the exclusion of any other elements. In addition, throughout the present specification and the claims which follow, a module means a unit that performs a specific function or operation, and can be realized by hardware or software, or a combination of both.

The term “electronic product” in the present specification may refer to an electronic device that is located in a user's residential space (e.g., a house or an office) and a vehicle and is configured for remote control. For example, the electronic product includes a set top box, a home theater, an air conditioner, a television (TV), a digital versatile disc (DVD) player, an internet protocol television (IPTV), a camera, a cleaner, a fan, a washing machine, a dryer, a boiler, an audio equipment, and a lighting equipment.

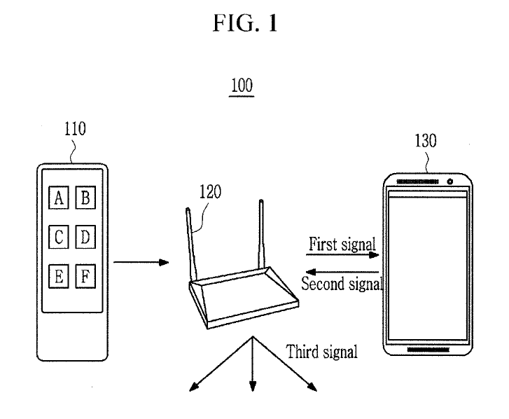

FIG. 1 shows a simplified configuration of a simultaneous control system for electronic products according to an exemplary embodiment of the present invention.

Referring to FIG. 1, the simultaneous control system 100 may include a remote control module (or a remote controller) 110, a relay module 120, and a user terminal 130. The remote control module 110 and the relay module 120 may be connected through a first communication network, and the relay module 120 and the user terminal 130 may be connected through a second communication network. For example, the first communication network may include an infrared communication network, and the second communication network may include one or more of a ZigBee network, a Bluetooth network, a near field communication (NFC) network, and a Z-Wave network.

The relay module 120 may receive a first signal output from the remote control module 110, may transmit the received first signal to the user terminal 130, and may receive a second signal output from the user terminal 130. The relay module 120 may output a plurality of third signals for respectively controlling operations of the plurality of electronic products based on the received second signal.

The remote control module 110 may include a body and a plurality of buttons A, B, C, D, E, and F that are coupled to the body and are operated by the user. The remote control module 110 may output a signal corresponding to a button operated by the user. The user may separate the buttons from the body.

The user terminal 130 may be provided with a program for executing a simultaneous control method using the simultaneous control system 100. The program may be disposed in a form of an application. The application may be disposed by default in the user terminal 130 or directly disposed by the user in the user terminal. For example, the user terminal 130 may include a desktop computer, a notebook computer, a smart phone, a tablet personal computer (PC), and a mobile communication device.

The user terminal 130 may automatically execute the application when the first signal transmitted from the relay module 120 is received and may search the second signal corresponding to the first signal to transmit the second signal to the relay module 120. The second signal may include control information related to the electronic products corresponding to the first signal.

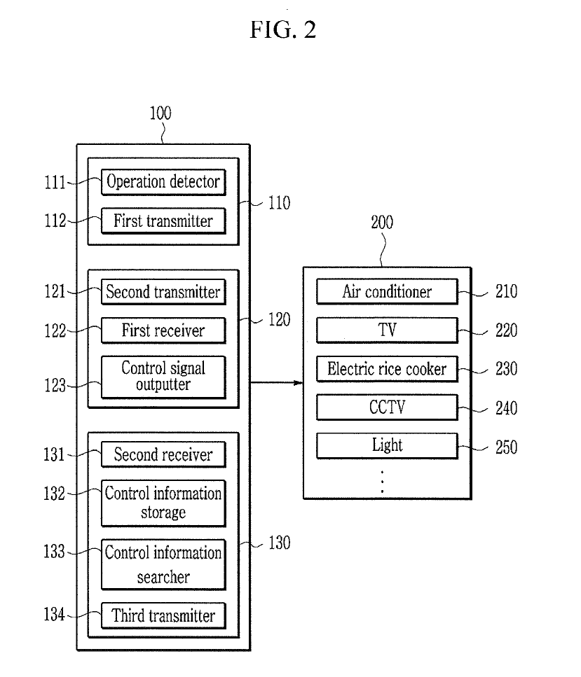

Hereinafter, a configuration of the simultaneous control system will be described in detail with reference to FIG. 2.

FIG. 2 shows a detailed configuration of the simultaneous control system for the electronic products according to an exemplary embodiment of the present invention.

Referring to FIG. 2, the remote control module 110 may include an operation detector 111 and a first transmitter 112.

The operation detector 111 may detect whether the user operates or manipulates the plurality of buttons.

The first transmitter 112 may generate and output the first signal corresponding to the operation button when the user's operation is detected by the operation detector 111. The first signal may include button information. For example, when the user operates a button an in the remote control module 110 of FIG. 1, a first a signal corresponding to the button A may be output. When the user operates a button B, a first b signal may be output.

The relay module 120 may include a second transmitter 121, a first receiver 122, and a control signal outputter (or a control signal output device) 123.

The second transmitter 121 may receive the first signal output from the first transmitter 112 and may transmit the received first signal to the user terminal 130.

The first receiver 122 may receive the second signal transmitted from the user terminal 130 receiving the first signal. The second signal may include control information corresponding to the electronic products.

The control signal outputter 123 may output a control signal for controlling an operation of the electronic products 200 based on the second signal received from the first receiver 122. The control signal outputter 123 may simultaneously or at predetermined time intervals output a first control signal for controlling the air conditioner 210, a second control signal for controlling the TV 220, a third control signal for controlling an electric rice cooker 230, a fourth control signal for controlling an closed circuit television (CCTV) 240, and an nth control signal for controlling a light 250 based on the control information included in the second signal.

The user terminal 130 may include a second receiver 131, a control information storage 132, a control information searcher 133, and a third transmitter 134.

The second receiver 131 may receive the first signal transmitted from the second transmitter 121.

The control information storage 132 may store the control information for the electronic products. The control information may include an electronic product control list corresponding to buttons of the remote control module 110. For example, the electronic products that are control objects, an order of control, and control items corresponding to the buttons may be stored in the electronic product control list, as shown in Table 1 below.

TABLE 1

| Button | Order | Electronic product | Control item |
|---|---|---|---|
| A | \textcircled{1} | TV | Power-off |
| | \textcircled{2} | Boiler | Switching to out mode |
| | \textcircled{3} | Gas stove | Locking valve |
| B | \textcircled{1} | Boiler | Power-off |
| | \textcircled{2} | Light A | Power-off |
| | \textcircled{3} | Light B | Illumination stage 1 |

| | |
|---|---|
| . . . | . . . |

. . .

The control information searcher 133 may search the control information corresponding to the first signal received from the second receiver 131. The control information searcher 133 may extract the electronic product control list corresponding to the button information included in the first signal from the control information stored in the control information storage 132.

The third transmitter 134 may generate the second signal including the control list searched by the control information searcher 133 and may transmit the second signal to the relay module 120.

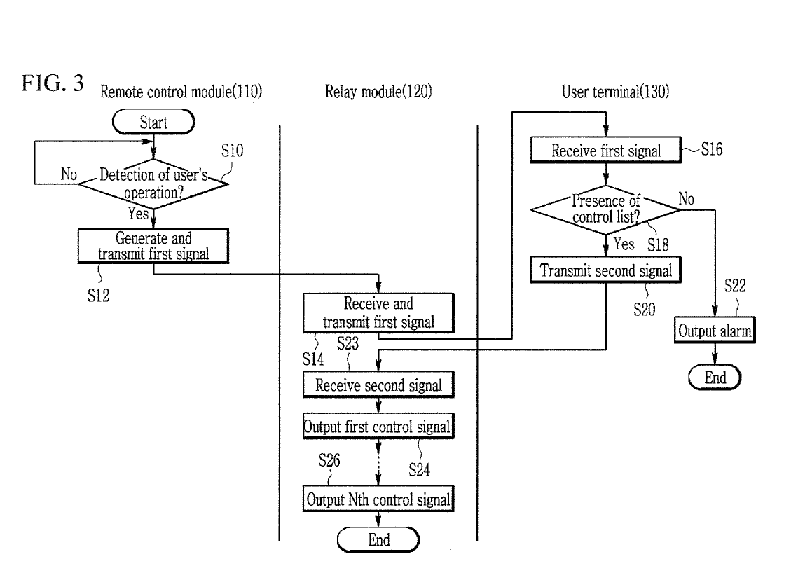

FIG. 3 shows a method for simultaneously controlling the electronic products using the simultaneous control system of FIG. 2.

Referring to FIG. 3, in a step S10, the user's button operation may be detected by the operation detector 111 of the remote control module 110.

In a step S12, when the button operation is detected in the step S10, the first signal corresponding to the user's button operation may be generated and may be output from the first transmitter 112.

In a step S14, the first receiver 122 of the relay module 120 may receive the first signal outputted in the step S12 and the second transmitter 121 may transmit the received first signal to the user terminal 130.

In a step S16, the second receiver 131 of the user terminal 130 may receive the first signal transmitted in the step S14. In a step S18, the control information searcher 133 may search the control list corresponding to the first signal received in the step S16. The control list corresponding to the button information included in the first signal may be extracted from the control information storage 132.

In a step S20, the third transmitter 134 may transmit the second signal including the control list searched in the step S18 to the relay module 120. In a step S22, when the control list corresponding to the button information included in the first signal is not found in the step S18, an alarm may be output in a form of a text message or a warning sound from the user terminal 130.

In a step S23, the first receiver 122 of the relay module 120 may receive the second signal transmitted in the step S20.

In a step S24 and a step S26, the control signal outputter 123 may output the control signal based on the second signal received in the step S23. The control signal outputter 123 may output the first control signal, the second control signal, the third control signal, and the nth control signal corresponding to the control list included in the second signal. The first control signal, the second control signal, the third control signal, and the nth control signal may be sequentially or almost simultaneously output based on the order of the control list.

The electronic products 200 may receive the first control signal, the second control signal, the third control signal, and the nth control signal through a network and may perform functions of the electronic products in response to the received control signals.

The method for simultaneously controlling the electronic products according to an exemplary embodiment of the present invention may be implemented by a program to be recorded in a recording medium readable by a computer. The computer may include a desktop computer, a notebook computer, a smart phone, a tablet personal computer (PC), a personal digital assistant (PDA), and a mobile communication device. The recording medium may include a read only memory (ROM), a random access memory (RAM), compact disc (CD)-ROMs, magnetic tapes, floppy disks, flash drives, smart cards, and optical data storage devices.

According to the exemplary embodiment of the present invention, the user may freely set and modify the control information including types of the electronic products controlled, a function of the electronic product controlled, and an order of control of the electronic products using the application disposed in the user terminal. According to the exemplary embodiment of the present invention, the user may differently set the control information corresponding to each button of the remote control module based on the user's residential environment, the user's usage habits of the electronic products, or a purpose of the user's going out. Thus, the exemplary embodiment of the present invention may control the electronic products with the user's single manipulation of the remote control module to improve convenience of the user.

The exemplary embodiment of the present invention may control the electronic products with the user's single manipulation of the remote control module, which is a physical operation system, to enlarge an age group of the user and reduce control complexity regarding the electronic products in a smart home environment. Further, the exemplary embodiment of the present invention may improve control efficiency of the electronic products using control of power cut-off and mode switching for the electronic products before the user goes out.

For convenience in explanation and accurate definition in the appended claims, the terms “upper”, “lower”, “internal”, “outer”, “up”, “down”, “upper”, “lower”, “upwards”, “downwards”, “front”, “rear”, “back”, “inside”, “outside”, “inwardly”, “outwardly”, “internal”, “external”, “internal”, “outer”, “forwards”, and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described to explain certain principles of the invention and their practical application, to enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A simultaneous control terminal for electronic products connected through a network with a relay module receiving and outputting a first signal that is output from a remote control module in response to a user's operation, comprising:
a control information storage configured to store control information corresponding to the remote control module;
a receiver configured to receive the first signal output from the relay module;
a control information searcher configured to search the control information corresponding to the received first signal; and
a transmitter configured to generate a second signal including the searched control information and transmit the second signal to the relay module.

2. The terminal of claim 1, wherein the control information includes the electronic products to be controlled, an order of control of the electronic products, and control items of the electronic products.

3. A simultaneous control system for electronic products, comprising:
a remote control module configured to output a first signal corresponding to a user's operation through a first communication network;
a relay module configured to receive the first signal through the first communication network and output the received first signal through a second communication network; and
a user terminal configured to receive the first signal transmitted from the relay module through the second communication network, generate a second signal including control information corresponding to the received first signal, and transmit the second signal to the relay module.

4. The system of claim 3, wherein the remote control module includes a body and a plurality of buttons detachable from the body and the first signal corresponding to a button operated by the user among the buttons is output.

5. The system of claim 3, wherein the relay module receives the second signal transmitted from the user terminal and outputs a plurality of control signals corresponding to the received second signal.

6. The system of claim 3, wherein the control information includes the electronic products to be controlled, an order of control of the electronic products, and control items of the electronic products.

7. A non-transitory computer-readable recording medium recording a program executing a simultaneous control method using a simultaneous control terminal for electronic products connected through a network with a relay module receiving and outputting a first signal that is output from a remote control module in response to a user's operation, comprising:
a function to store control information on the electronic products in a control information storage;
a function to receive the first signal output from the relay module in a receiver;
a function to search the control information corresponding to the first signal received by a control information searcher; and
a function to generate a second signal corresponding to the searched control information and transmit the second signal to the relay module.

8. The non-transitory computer-readable recording medium of claim 7, wherein the first signal includes button information related to the remote control module and the control information includes the electronic products to be controlled, an order of control of the electronic products, and control items of the electronic products.

9. The non-transitory computer-readable recording medium of claim 7, wherein the control information is set and modified by the user.
